(19) United States
(12) Patent Application Publication
(10) Pub. No.: US 2013/0332527 A1
(43) Pub. Date: Dec. 12, 2013

(54) METHOD AND APPARATUS FOR ORGANIZING A GROUP EVENT

(71) Applicants: Nan Du, Beijing (CN); Hao Wang, Beijng (CN); Wei Wang, Beijing (CN); Feng Zhao, Beijing (CN); Dong E. Liu, Beijing (CN); Wenwei Xue, Beijing (CN); Alix Lik Hang Chow, Beijing (CN); Jiang Li, Beijing (CN); Kangjian Meng, Beijing (CN); Zhanjiang Song, Beijing (CN); Hao Yang, Montrose, NY (US)

(72) Inventors: Nan Du, Beijing (CN); Hao Wang, Beijng (CN); Wei Wang, Beijing (CN); Feng Zhao, Beijing (CN); Dong E. Liu, Beijing (CN); Wenwei Xue, Beijing (CN); Alix Lik Hang Chow, Beijing (CN); Jiang Li, Beijing (CN); Kangjian Meng, Beijing (CN); Zhanjiang Song, Beijing (CN); Hao Yang, Montrose, NY (US)

(73) Assignee: NOKIA CORPORATION, Espoo (FI)

(21) Appl. No.: 13/812,358

(22) PCT Filed: Jul. 2, 2010
(86) PCT No.: PCT/CN10/74929

§ 371 Date: Aug. 26, 2013

(51) Int. Cl. H04L 29/06

(52) U.S. Cl. CPC H04L 65/403
USPC 709/204

(57) ABSTRACT

An approach is provided for organizing a group event. An input from a device specifying a group event is received. A location associated with the group event is determined. One or more other devices within a proximity of the location are determined. A notification of the group event to the one or more other devices is generated.

### BACKGROUND

Service providers and device manufacturers (e.g., wireless, cellular, etc.) are continually challenged to deliver value and convenience to consumers by, for example, providing compelling network services. Such services can often include shopping services and/or related marketing services. One area of interest has been the development of services that pre-negotiate marketing promotions or discounts with a retailer to users based on, for example, the number of users that participate in the promotion (e.g., the number of users who form a group as part of the promotion). However, it is noted that shopping is often opportunistic and impulsive and, therefore, pre-negotiated marketing promotions often are not suitable for forming such groups on the fly. Accordingly, service providers and device manufacturers face significant technical challenges to enabling users to dynamically for ad-hoc groups to participate shopping and other group-based activities.

### Some Example Embodiments

Therefore, there is a need for an approach for efficiently organizing a group event (e.g., a group purchase event).

According to one embodiment, a method comprises receiving an input from a device specifying a group event. The method also comprises determining a location associated with the group event. The method further comprises determining one or more other devices within proximity of the location. The method also comprises generating a notification of the group event to the one or more other devices.

According to another embodiment, an apparatus comprises at least one processor, and at least one memory including computer program code, the at least one memory and the computer program code configured to, with the at least one processor, cause, at least in part, the apparatus to receive an input from a device specifying a group event. The apparatus is also caused to determine a location associated with the group event. The apparatus is further caused to determine one or more other devices within proximity of the location. The apparatus is also caused to generate a notification of the group event to the one or more other devices.

According to another embodiment, a computer-readable storage medium carries one or more sequences of one or more instructions which, when executed by one or more processors, cause, at least in part, an apparatus to receive an input from a device specifying a group event. The apparatus is also caused to determine a location associated with the group event. The apparatus is further caused to determine one or more other devices within proximity of the location. The apparatus is also caused to generate a notification of the group event to the one or more other devices.

According to another embodiment, an apparatus comprises means for receiving an input from a device specifying a group event. The apparatus also comprises means for determining a location associated with the group event. The apparatus further comprises means for determining one or more other devices within proximity of the location. The apparatus also comprises means for generating a notification of the group event to the one or more other devices.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of organizing a group event, according to one embodiment;

FIG. 2 is a diagram of the components of user equipment, according to one embodiment;

FIG. 3 is a diagram of the components of a group purchasing platform, according to one embodiment;

FIG. 4 is a flowchart of a process for organizing a group event, according to one embodiment;

FIGS. 5A-7D are diagrams of user interfaces utilized in the processes of FIG. 4, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for organizing a group event are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

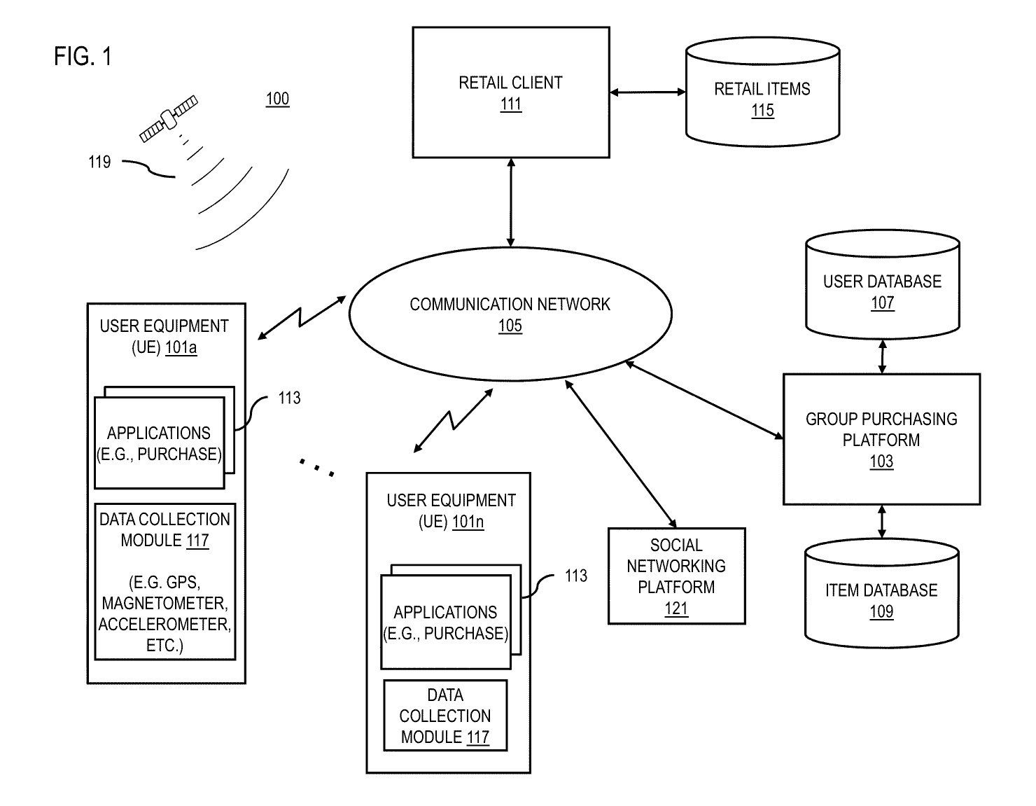

FIG. 1 is a diagram of a system capable of organizing a group event, according to one embodiment. As used herein, the term group event refers to an event where a plurality of users may be utilized to perform a task, such as purchasing items for a discount. Although various embodiments are described with respect to a group purchasing event, it is contemplated that the approach described herein may be used with other events when groups can be organized, such as a social event (e.g., dating, hiking, sports events, etc.), a travel event (e.g., a trip to a particular location, accessing a cab for travel, etc.), etc.

Traditionally, group purchasing at retail establishments has occurred using word of mouth and manual communications. As such, grouping occurs manually with contacts already known to a user. In recent times, group purchasing of items has occurred using the internet. For example, certain websites on the internet allow users to purchase goods as a group for discounts. One such example is Groupon™, which allows for users to receive a coupon based on a quantity discount from a retailer. When a certain number of people sign up for a group discount made available on the website, the coupon with the discounted price based on quantity will be triggered and made available to the people.

Other services additionally enable retailers to sell their products at the price of group buying. As such, retailers can broadcast a group buying marketing promotion to consumers. Then, consumers can browse the promotions to obtain discounts based on bulk purchasing from the retailers. Other services include grouping people to receive bulk discounts at online retailers. For example, a group can be formed to purchase items from an online retailer at bulk prices as a single entity. However, these services fail to address circumstances of an individual finding out about a group discount deal at a retail establishment and organizing a group to take advantage of the group discount deal. This organization can occur within a certain time limit because the user may wish to move to another location and/or the retail establishment may only consider offering the deal for a limited time. Further, there may be significant challenges to determining other users to include in group purchasing events based on amounts of information about the other users.

To address this problem, a system 100 of FIG. 1 introduces the capability to organize group events. Group events can be organized to take advantage of opportunistic and/or impulsive options available to one or more users. These group events can be associated with one or more categories and/or subscriptions based on user inputs. As such, users may receive notifications about group events that the user may find relevant. Further, consumer users and/or retail users may publish notifications based on subscription information, context information, category of retail publications, or a combination thereof associated with other consumer users (e.g., subscriber users). Contextual information may include a location of a device associated with the other consumers in comparison with a location associated with the group event. As such, consumer users that are within a proximity of the location of the group event can be selected as possible attendees of the group event.

In one example, with this approach, a user can enter an establishment (e.g., a store, a restaurant, a ticketing agency, a hotel, etc.) and talk to or haggle with a representative (e.g., a sales associate, manager, etc.) of the store. In response the representative or the user may propose a deal or arrangement to purchase one or more items. The deal may include purchasing at least a certain amount of items to receive a certain total or per item price. The user, however, may only want a single or a certain number of the items less than the amount of items. In order to receive the deal, the user can search of additional users to partake in a group purchasing event at the retail establishment. In certain examples, the deal may be time sensitive, in which case, users that are nearby the establishment and/or can arrive at the establishment before a predetermined time can be selected as potential members of the group purchasing event. When group members are invited and/or arrive at the group purchasing event, the users can purchase the items and receive the deal (e.g., a discount, extra goods and/or services, etc.).

As shown in FIG. 1, user equipment (UEs 101a-101n) can connect to a group purchasing platform 103 over a communication network 105 to utilize group purchasing services. Moreover, the group purchasing platform 103 can retrieve information associated with one or more users via a user database 107 and purchasable items from an item database 109. These databases 107, 109 may be utilized to provide the group purchasing services to the UEs 101 and/or a retail client 111. UEs 101 can use an application 113 (e.g., a purchase application) to upload information about a particular item to the group purchasing platform 103. In certain examples, the retail client 111 can be a UE 101. For example, a retail client 111 and/or UE 101 can be utilized to upload information about retail items 115 (e.g., retail items 115 associated with a retail store, other purchasable items such as goods and/or services, etc.) to the group purchasing platform 103. In this manner, purchasing information can be transmitted to the item database 109 of the group purchasing platform 103.

The group purchasing platform 103 receives the input, from a UE 101, specifying a group event. The input can specify one or more parameters associated with the group event. For example, the parameters may include one or more categories of group events associated with the group event. Additionally or alternatively, the parameters may include criteria for determining one or more other UEs 101 to which to send a notification about the group event. In another example, the parameters can include location information of the group event. The group purchasing platform 103 can then determine a location associated with the group event, which may be based on the location of the UE 101 and/or another location associated with the group purchasing event (e.g., an establishment address, establishment location coordinates, address of user, etc.). The location can be specified in an input message and/or be determined based on information stored in the user database 107 and/or item database 109.

For example, the user database 107 may include user profiles associating each user with context information, subscription information, etc. These user profiles may be linked to an account of the user. In certain embodiments, context information is information that may dynamically change over time. For example, a location of a UE 101 associated with a user can be contextual information. In another example, other contextual user information such as user calendar event information, weather information, environmental sensor information, accelerometer information, compass information, etc.

Subscription user information may include one or more parameters utilized to determine the relevancy of a potential group event to the individual users. Such parameters can include categories of group events that the user indicates the user may wish to participate in. For example, categories for purchasing events can include types of goods (e.g., furniture, home and garden, bed and bath, clothing, shoes, accessories, electronics, sports, books, media, etc.) as well as subcategories of such goods (e.g., electronics may include computers, video games, cameras, portable media players, navigation equipment, cell phones, etc.).

The item database 109 may include information about one or more group events and/or items associated with the group events. For example, the item database 109 may include categorical information associated with the items (e.g., products, services, etc.) The categorical information may be stored in a data structure (e.g., a tree) and include one or more subcategories. Further, the item database 109 can include a description of the event and/or a description of one or more associated items.

Location information as well as other contextual information about a user can be collected and monitored at the group purchasing platform 103. In certain embodiments, an application 113 on the UE 101 can monitor contextual information associated with a data collection module 117 of the UE 101. For example, the data collection module may utilize a location determination sensor system, such as a Global Positioning System (GPS) to access GPS satellites 119 to determine the location of the UE 101. The UE 101 may then cause transmission of the contextual information (e.g., the location information) to the group purchasing platform for processing. The group purchasing platform 103 can receive the contextual information and store the contextual information in a user profile associated with the user in the user database 107. In certain embodiments, the user profile may include an identifier of the user (e.g., a username) and/or an identifier of the UE 101 (e.g., a hardware identifier such as an International Mobile Equipment Identity (IMEI), a phone number, an Internet Protocol address, etc.).

Received criteria associated with the input can be parsed to determine which users may be candidates to send notifications about the group event to. The criteria can include one or more parameters or rules about contextual information or other information associated with the candidates. For example, the criteria can include one or more associations with the location of the candidates. The criteria can thus include one or more relationships between the location of the group event and the location of users. In one example, the relationship can be whether the candidates are within a proximity or range of the location of the group event. In another example, the relationship can be whether the candidates are within a predetermined geographic area (e.g., geographic parameters of a park, a mall, etc.) associated with the event location. Further, criteria can include a quantity of candidates that are needed and/or a quantity of items that need to be purchased to get a particular discounted price. Moreover, criteria can include a time when the group event would occur. The time of the group event can be correlated to calendar events of the candidates to determine whether the candidates are available. In yet another example, the criteria can include rules about the candidate.

In one example, the rules about the candidate can include rules about a rating or credit value associated with the candidate. In certain embodiments, a peer rating can be utilized to determine a credit value (e.g., for credibility) associated with users. A high credit value can be associated with a productive user that would likely be desirous in a group event. A low credit value can be associated with a less desirous user (e.g., a user that is difficult to work with, quits from the group, etc.). A rating associated with a candidate can be based on reviews from other users that have dealt with the candidate before. For example, if the candidate says that the candidate will go to a group event, but does not, the candidate can receive a negative rating, which may affect the candidate's credit value, while if the candidate was helpful (e.g., actively contributed) in a previous group event, the candidate can receive a positive rating raising the candidate's credit value. Additionally, if the initiating user cancels a group event and/or the group event does not conform to the initiating user's description, the initiating user can receive a negative rating affecting the initiating user's credit value.

In another example, the rules about the candidate can include rules about social connectivity of the candidate to the initiating user. For example, the initiating user and/or candidate(s) can be associated with one or more social networks on one or more social networking platforms 121. Examples of social networking services include networks in which users can interact with other users. In certain examples, user may update profiles to interact and show information about the user to others. Information associated with the social networking platform 121 may be utilized as criteria for determining and/or filtering candidates. For example, a candidate's social distance from the user (e.g., based on one or more degrees of separation from which the user and the candidate may be connected). In one example, the criteria provides a preference to selecting a candidate to send a notification if the candidate is a direct contact of the initiating user. In another example, the candidates not within a certain social distance of the initiating user can be filtered. In certain embodiments, the group purchasing platform 103 can contact the social networking platform 121 (e.g., via an application programming interface) to retrieve social networking information utilized as criteria parameters. In other embodiments, the UE 101 of the initiating user can retrieve the social networking information.

Moreover, the candidates (e.g., subscription users) can set criteria that can be stored in the user profiles. As previously noted, such criteria can include selected relevant categories of events. Further, the criteria can include subscription information about proximity of the subscription user to the event. For example, the subscription user can set a user profile parameter so that the user only gets notifications of group events if the subscription user is within a threshold range of the event (e.g., based on a location of a UE 101 associated with the subscription user).

Matching based on one or more criteria set by the subscription user and/or user initiating or publicising the group event can be accomplished by the group purchasing platform 103. The group purchasing platform 103 can then determine the candidates based, at least in part, on the matching. In certain embodiments, if an exact match(s) are not found, the criteria set by the initiator of the group event can be relaxed to find additional candidates. In one embodiment, once the group purchasing platform 103 determines the candidates based on the criteria, a notification can be generated and sent to the UEs 101 of the candidates. In another embodiment, information about the candidates can be sent to the initiating UE 101 and the initiating user can select from the candidates which candidates the user wishes to invite to the group event. Then, the notification can be sent based on the selection.

The candidate UEs 101 can receive the notification. In certain examples, the notification may include a description of the group event (e.g., any items associated with the group event, categories associated with the group event, etc.) as well as information about associated criteria (e.g., a target time to be at the group event, a number of items needed to be purchased, etc.). The candidate can view the options and determine whether the candidate wishes to join the group event. If the candidate wishes to participate in the group event, the candidate can send a message to the group purchasing platform 103 and/or the UE 101 of the initiating user. When the necessary amounts of users are gathered, another notification can be sent notifying the candidates that the group event is closed. Then, the users can partake in the group event. After the event, one or more members of the group may be asked to rate the initiating user and/or the other users partaking in the group event. This may include a rating as to whether the user was difficult, whether the initiating user correctly identified the group event, whether the candidate users attended and/or attended on time, etc. The rating may be utilized to adjust a credit value for each user (e.g., for rating the credibility of the user).

In one example, an initiating user arrives at a store in a mall and converses with an employee of the store. The employee indicates that a cellular phone that the initiating user is viewing can be purchased for a first price, however if five cellular phones are purchased together within an hour, the cellular phones can be sold for a second price lower than the first price. The initiating user does not need five cellular phones, so the initiating user decides to logon to the group purchasing platform 103 utilizing a purchase application 113. The application 113 can be in the form of a web browser browsing to a web portal associated with the group purchasing platform 103, a widget, a native application 113 that has an application programming interface (API) that can connect to the group purchasing platform 103, etc. The user specifies criteria associated with a group purchasing event associated with the five cellular phones. For example, the criteria can include that candidates to send notifications to should be within the mall, within a certain range of the mall, within a certain range of the initiating user's UE 101, etc. The criteria may also include one or more parameters dealing with ratings associated with the candidates. The group purchasing platform 103 can send out notifications to candidates matching the criteria as described above. The initiating UE 101 then receives responses from one or more of the candidates receiving notification. When enough users are organized to take advantage of the group buying event, the group purchasing platform 103 and/or the purchasing application 113 can determine to send a notification to other users saying that the group event is full. Then, the users can partake in the group purchasing event to buy the cellular phones.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, group purchasing platform 103, and retail client 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the group purchasing platform 103 may interact according to a client-server model with the applications 113 of the UE 101. According to the client-server model, a client process sends a message including a request to a server process, and the server process responds by providing a service (e.g., group organization, group purchasing, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

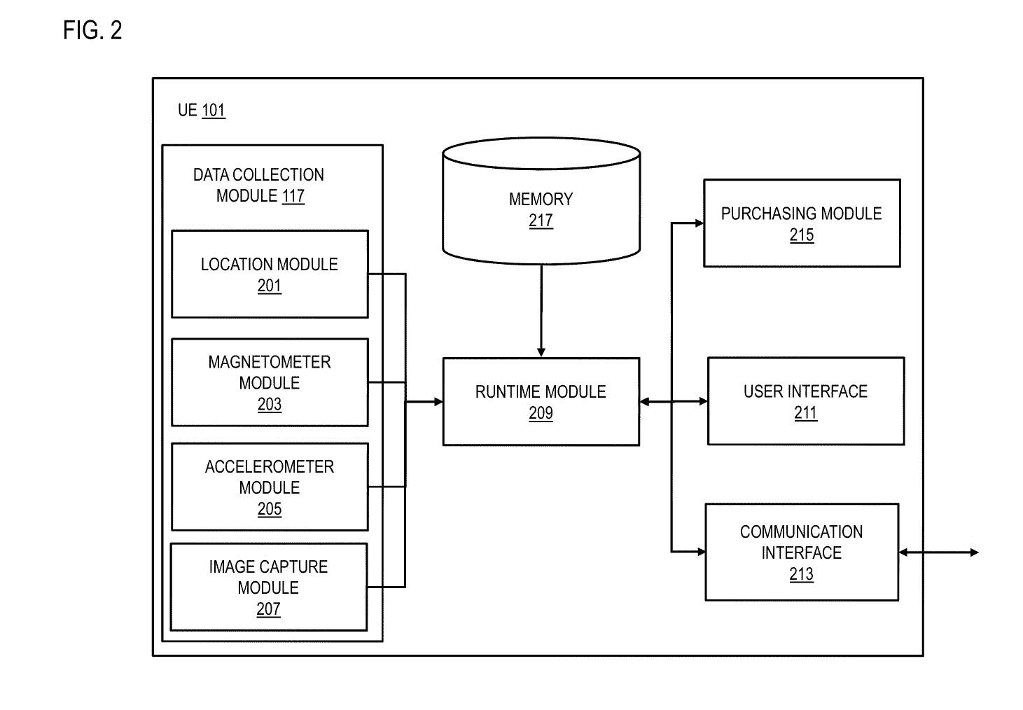

FIG. 2 is a diagram of the components of user equipment, according to one embodiment. By way of example, a UE 101 includes one or more components for facilitating organizing group events. It is contemplated that the functions of these components may be combined in one or more components or performed by other components of equivalent functionality. In this embodiment, the UE 101 includes a data collection module 117 that may include one or more location modules 201, magnetometer modules 203, accelerometer modules 205, and image capture modules 207, the UE 101 can also include a runtime module 209 to coordinate the use of other components of the UE 101, a user interface 211, a communication interface 213, a purchasing module 215, and memory 217. An application 113 (e.g., a purchasing application) of the UE 101 can execute on the runtime module 209 utilizing the components of the UE 101.

The location module 201 can determine a user's location. The user's location can be determined by a triangulation system such as GPS, assisted GPS (A-GPS), Cell of Origin, or other location extrapolation technologies. Standard GPS and A-GPS systems can use satellites 119 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 217 and are transmitted to the group purchasing platform 103 via the communication interface 213. Moreover, in certain embodiments, the GPS coordinates can include an altitude to provide a height. In other embodiments, the altitude can be determined using another type of altimeter. Further, the location module 201 can utilize wireless local area networking location sensing technologies and/or other types of indoor location technologies to determine locations. With this approach, users' locations within buildings can be sensed.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of an image capture device (e.g., a camera) can be marked as a reference point in determining direction. The image capture device can provide image information from a sensor to the image capture module 207. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 217 and/or transmitted via the communication interface 213 to the group purchasing platform 103. This may be utilized to determine where a traveling user is going. For example, if the user is traveling away from a group event at a certain speed (e.g., determined by location information as well as directional information), the group purchasing platform 103 may determine not to send a notification of the group event to the user.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of the image capture device can be marked as a reference point in determining direction. Because the acceleration due to gravity is known, when a UE 101 is stationary, the accelerometer module 205 can determine the angle the UE 101 is pointed as compared to Earth's gravity. In one embodiment, vertical directional data obtained from an accelerometer is embedded into the metadata of captured or streaming media or otherwise associated with the UE 101 by the purchase application 113. In certain embodiments, the magnetometer module 203 and accelerometer module 205 can be means for ascertaining a perspective of a user. This perspective information may be stored in the memory 217 and sent to the group purchasing platform 103. Further, because the Earth's gravity is known, the accelerometer module 205 may be utilized as a base point for determining magnetometer information.

Moreover, the image capture module 207 can capture sill images and/or video from an image sensor. Further, audio information may be retrieved from a microphone input source associated with the UE 101. The image capture module 207 can be utilized to capture images, video, and/or media associated with an item or items to be purchased during a group purchasing event and/or other images that can be useful in defining a group event. This graphical information can be transmitted to the group purchasing platform 103 as part of a description associated with a specified group event.

In one embodiment, the communication interface 213 can be used to communicate with the group purchasing platform 103 or other UEs 101. Certain communications can be via methods such as an internet protocol, messaging (e.g., Short Message Service (SMS), Multimedia Messaging Service (MMS), etc.), or any other communication method (e.g., via the communication network 105). In some examples, the UE 101 can send context information associated with the UE 101 to the group purchasing platform 103. In other examples, the user can utilize a user interface 211 to specify a group event to send to the group purchasing platform 103. Further, the communication interface 213 can be utilized to communicate with other UEs 101.

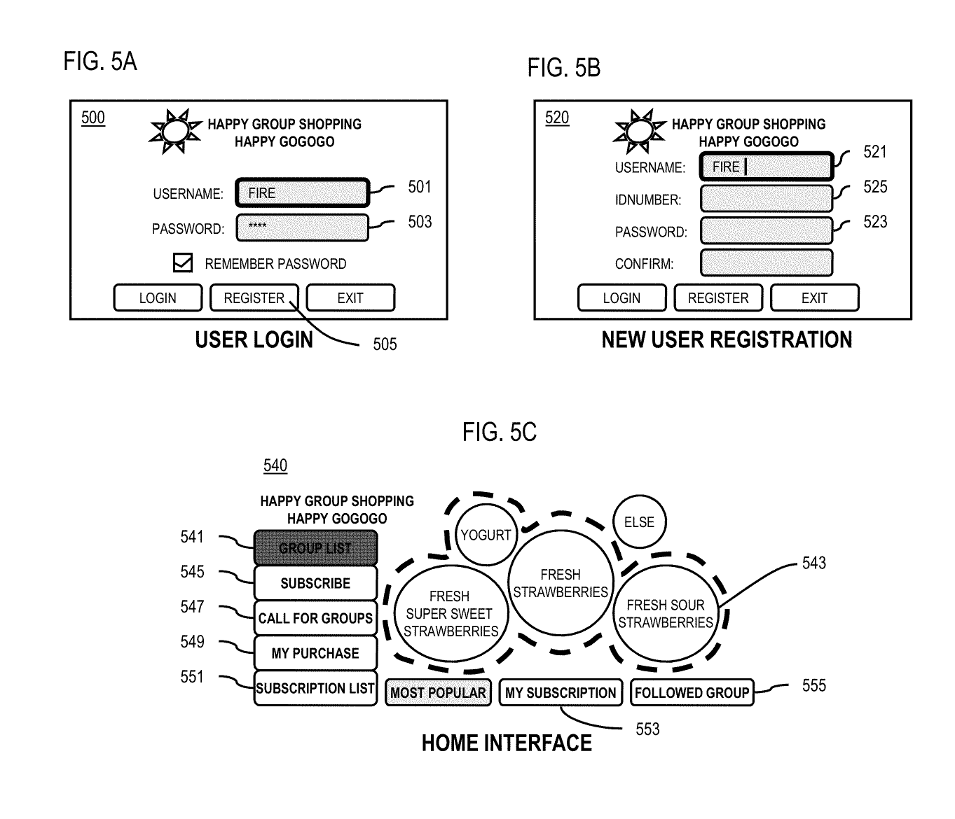

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc. In certain embodiments, the user interface 211 and/or runtime module 209 can be means for causing presentation of context-based grouping queries and results. Example user interfaces of such grouping queries, results, and actions performed as part of the results are shown in FIGS. 5A-7D.

The purchasing module 215 may be utilized in facilitating access of group event information for the UE 101 and/or the group purchasing platform 103. The purchasing module 215 can thus be utilized to collect context information associated with the user of the UE 101 and send the context information to the group purchasing platform 103. Further, the purchasing module 215 can be utilized in notifying a user of one or more group events as well as specifying group events.

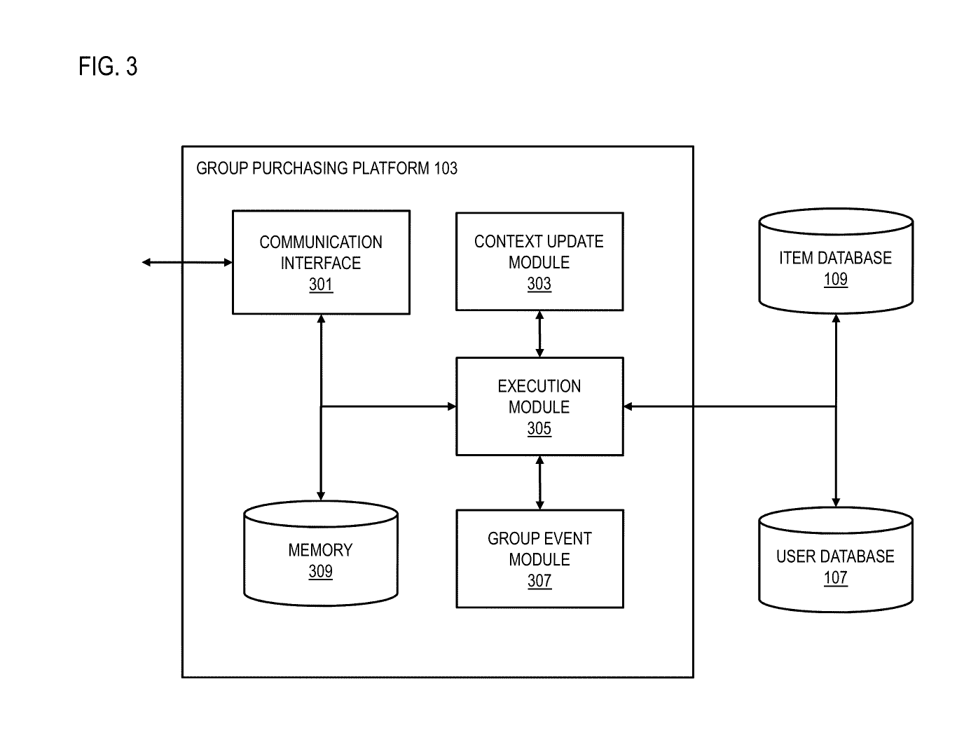

FIG. 3 is a diagram of the components of a group purchasing platform, according to one embodiment. By way of example, the group purchasing platform 103 includes one or more components for facilitating organization of group events (e.g., a group purchasing event). It is contemplated that the functions of these components may be combined in one or more components or performed by other components of equivalent functionality. In this embodiment, the group purchasing platform 103 includes a communication interface 301, a context update module 303, an execution module 305 that can execute processes, a group event module 307 that can be used to organize group events, and a memory 309.

The communication interface 301 can be used to communicate with a UE 101 as well as other devices connected on the communication network 105. The group purchasing platform 103 can receive information from the UE 101 via the communication interface 301 via methods such as internet protocol, MMS, SMS, GPRS, or any other available communication method. The UE 101 may further send information to the group purchasing platform 103 for many reasons, such as to update user profiles in the user database 107, group event information in the item database 109, etc.

The context update module 303 can receive context information from UEs 101 via the communication interface 301. The context update module 303 can then update user profiles in the user database 107 as well as other tables or data structures (e.g., indexes) utilized in sorting, grouping, or organizing user information based on the context information (e.g., user location information). Further, the execution module 305 may maintain other user profile information (e.g., user specified criteria on when to send notifications). User specified criteria of when to send notifications can include selection of one or more categories that may be relevant to the user, rules for sending notifications based on the user's location, etc.

The execution module 305 can additionally receive requests to initiate organization of a group event. The group event module 307 can receive a request from a UE 101 via the communication interface 301. Then, the group event module 307 can populate a data structure (e.g., a data structure in memory 309) associated with the request as well as information associated with the event (e.g., criteria for forming a group, location and/or context information, etc.). This data structure may be stored as part of the item database 109. Then, the group event module 307 can organize a group event for the UE 101 based on the criteria, context information, a combination thereof, etc.

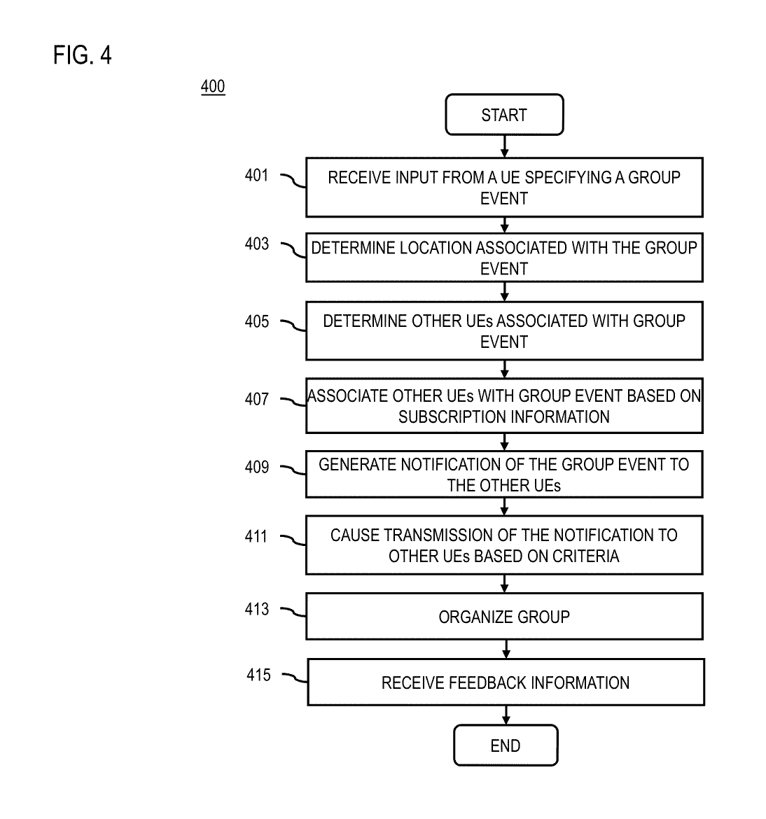

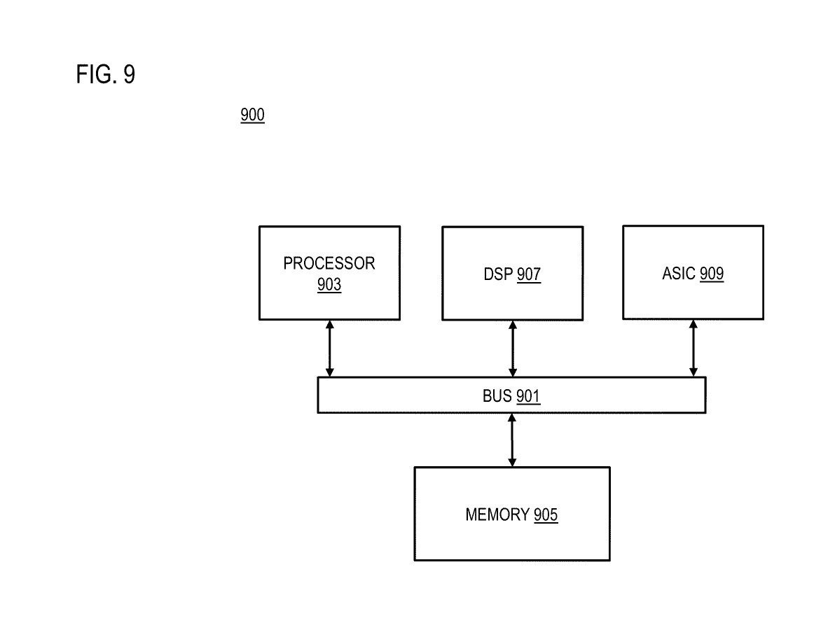

FIG. 4 is a flowchart of a process for organizing a group event, according to one embodiment. In one embodiment, the execution module 305 of the group purchasing platform 103 performs the process 400 and is implemented in, for instance, a chip set including a processor and a memory as shown in FIG. 9. As such, the execution module 305 can provide means for accomplishing various parts of the process 400 as well as means for accomplishing other processes in conjunction with other components of the group purchasing platform 103. Additionally or alternatively, the UE 101 may perform one or more aspects of the process 400.

At step 401, the execution module 305 of the group purchasing platform 103 receives an input from an initiating UE 101 (e.g., a device) specifying a group event (e.g., a group purchasing event). The input can specify criteria associated with the group event as previously detailed as well as a description of the group event. In the case of a group purchase, an image of one or more items for purchase can be included in the description of the group event. In certain embodiments, the group event can include a purchasing event, a social event, a travel event, etc. Moreover, the input can specify one or more categories associated with the event and/or subcategories associated with the event (e.g., types of items to purchase, pricing ranges, etc.).

Then, at step 403, the execution module 305 can determine a location associated with the group event. This location can be determined from information specified in the input and/or additional information received from the initiating UE 101. The location may be based upon a location of the initiating UE 101 (e.g., as determined by GPS or other location determination technologies), and/or another location associated with the group event (e.g., an establishment address, establishment location coordinates, address of user, etc.).

Then, at step 405, the execution module 305 determines one or more other UEs 101 that can be associated with the group event. The one or more other UEs 101 can be candidates for joining the group event. In certain embodiments, the association can be based on the proximity of the other UEs 101 to the determined location. This may occur because, for example, the other UEs 101 are within a predetermined range of the group event location, within a geographic boundary associated with the group event location, etc. The location of the candidate UEs 101 can be determined from one or more user profiles associated with each candidate UE 101. The user profiles can include location information of the candidate UEs 101 transmitted by the candidate UEs 101 to the group purchasing platform 103. As such, the group purchasing platform 103 can monitor the location of candidate UEs 101 (e.g., in real-time or near real-time). In this manner, momentary UE locations can be utilized in determining candidate UEs 101.

Further, at step 407, the candidate UEs 101 can be determined based, at least in part, on subscription information. As previously noted, subscription information may include criteria selected by the candidates. In one example, the execution module 305 determines one or more categories associated with the group event. Further, the execution module 305 determines respective subscription information corresponding to the one or more candidate UEs 101. The subscription information can be associated with the one or more categories. For example, subscription information stored in a user database 107 can be associated with respective user profiles of associated with the respective candidate UEs 101. The criteria (e.g., categories, distance from event, etc.) can be utilized determining candidate UEs 101 by matching and/or filtering candidate UEs 101.

The execution module 305 can then generate a notification of the group event to the candidate UEs 101 (step 409). The notification may include data associated with the group event. In certain embodiments, the notification can be pushed to the candidate UEs 101. The push mechanism can alert the users of the candidate UEs 101 when the notification is received. In one example, a respective purchasing application 113 of the candidate UEs 101 can receive the notification and be used to notify the user. In other embodiments, another form of communication (e.g., e-mail, SMS, MMS, automated voice calls, etc.) can be utilized for the notification.

The, at step 411, the execution module 305 determines to transmit the notification to one or more UEs 101 based on criteria. As previously noted, the criteria may utilize categorical information, subscription information, context information, etc. to determine the UEs 101 from the candidate UEs 101.

In one example, the context information may include a location of a particular candidate UE 101. The subscription information (e.g., user profile) associated with the candidate UE 101 can further include a distance parameter. The distance parameter can indicate a distance that the candidate UE 101 is from the group event location to be considered a candidate. An advantage to this approach is to allow the candidate UE 101 to filter out unwanted or irrelevant notifications (e.g., notifications that the user may consider spam). In certain embodiments, a user will only be transmitted a notification if the group event matches or substantially matches (e.g., partially matches) the user's criteria.

In another example, criteria associated with the group event can be utilized to determine candidate UEs 101 to notify. As previously noted, the notification can be based on a matching or partial matching of criteria (e.g., a rating/credit value of the candidate users, a location associated with the candidate users, an availability of the candidate users, a social distance of candidates, etc.).

Then, at step 413, the execution module 305 can organize a group for the group event. The execution module 305 can cause transmission of the notification module based on the criteria as mentioned above. In response to the transmission, the one or more candidate UEs 101 that were sent notifications can respond with an answer. For example, an answer may include whether the user is wishes to/is able to attend the group event. The answer may additionally include a quantity (e.g., a quantity the user wishes to purchase at a group purchasing event). Additionally, the criteria may include a maximum or target quantity. For example, a maximum quantity may be a quantity at which point an associated deal is no longer valid and/or a point at which an associated retailer does not have sufficient inventory quantity to fulfil. A target quantity may be a quantity at which point the deal benefit (e.g., a per item rate) is triggered.

The execution module 305 can receive one or more responses to the notification sent by respective candidate UEs 101. Then a group can be formed to engage in the group event based, at least on the one or more responses. In certain embodiments, when responses are received, the initiating user can receive a list of responses. The initiating user may then select one or more candidate UEs 101 that the initiating user may find desirable to attend the group event. Alternatively or additionally, the execution module 305 may sort the candidates based on one or more parameters (e.g., rating, distance from group event, etc.). For example, it may be more desirable for the initiating user to have a group event with users nearby because it may be quicker for the initiating user. In certain embodiments, a social distance or other social parameters associated with a social networking platform 121 can be utilized to sort and/or highlight user candidates. Some users may be more likely to trust user candidates that the user feels connected to (e.g., because the user candidate is a friend of a friend).

Then, at step 415, the execution module 305 can receive feedback information from one or more UEs 101. In certain examples, this may include receiving one or more other inputs specifying a rating or a review for one of the candidates invited to attend the group event, the initiating user, or a combination thereof. Further, once the rating is received, a historical rating can be determined (e.g., calculated based on averages and/or other algorithms) for each respective user receiving a rating. The one or more other inputs can be received from the initiating UE 101, one or more candidate UEs 101, etc. According to certain embodiments, the initiating UE 101 may be associated with a vendor associated with the group event. Moreover, the feedback information may include parameter settings for individual users for one or more of the users' user profiles. For example, one of the users may determine to blacklist one of the other users (e.g., the initiating user and/or a candidate user) from future events initiated by the user. Further, the user may add criteria to the user's profile to filter out notifications from group events where the other user is invited and/or is attending. Alternatively or additionally the criteria can cause an additional notification to occur if the other user is attending and/or is part of a group notification to which the user is notified of. A user may find this useful to limit contact with other users the user may dislike.

FIGS. 5A-7D are diagrams of user interfaces utilized in the processes of FIG. 4, according to various embodiments. FIG. 5A shows a user interface 500 to login to a service of the group purchasing platform 103. The user can enter a username 501 and password 503 to access a user account tied to the user. As previously mentioned, a user profile may be tied to the user account. If the user does not have an account, the user is afforded the opportunity to register 505.

FIG. 5B shows a new user registration user interface 520, according to one embodiment. The user is able to register by entering a username 521, password 523, and confirmation for the password, an identification number 525, and other common information entered into a registration process (e.g., name, address, phone number, e-mail, etc.). In certain embodiments, the identification number 525 may be associated with a particular UE 101 of the user and/or be assigned as part of the registration process. Further, some information can be gathered at the time of registration and other required information may be gathered later, before one or more services are performed to allow the user to quickly and easily register.

FIG. 5C shows a home user interface 540 of a service associated with the group purchasing platform 103. The user interface 540 can include a group list 541 associated with a list of group buying activities. Popular group buying activities may additionally be presented to the user in an area 543 of the user interface 540. Moreover, the user can subscribe 545 to one or more categories of group buying events the user may be interested in. Additionally, the user can publish new group purchasing events using a call for groups 547 option. A history of groups that the user has previously joined or is currently joined in can be provided using a “my purchase” option 549. The user may additionally utilize a subscription list 551 to view one or more options of available subscriptions to group purchasing events. The user may additionally view a list of the user's subscriptions using a “my subscription” option 553. Moreover, the user may follow groups and/or other users that form groups using a “followed group” option 555. Additionally or alternatively, a subscription option can be utilized to subscribe to group events created by a particular user.

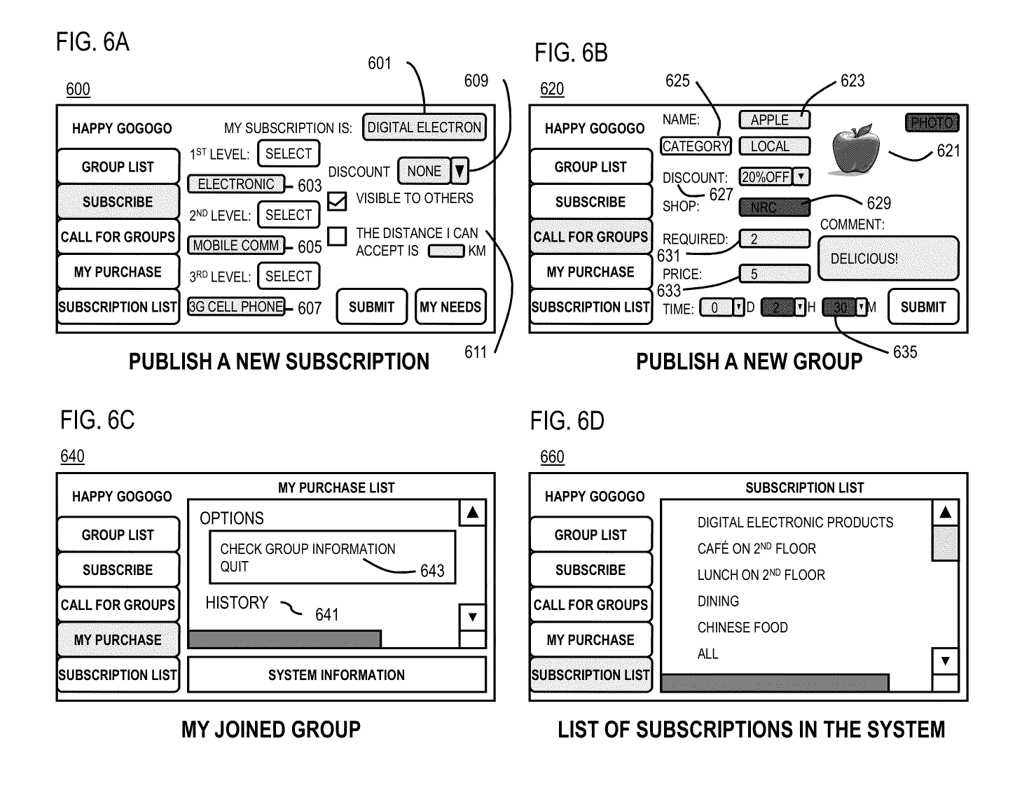

FIG. 6A shows a user interface 600 showing a creation of a new subscription option. The subscription can include a digital electronics subscription 601. The digital electronics subscription 601 can include options for multiple levels of categories that the user is interested in. For example, layered subcategories can include electronics 603, mobile communications 605, and 3G cellular phones 607. Moreover, preferences can be set to how much of a discount 609 the user desires before being notified of a group event. For example, the user may choose a percentage from the regular sale price or a price range (e.g., a total price, a discount amount, etc.). The user can additionally set a distance option 611 where the user can set a distance from a group event that the user needs to be within before being sent a notification about the group event. As such, the user need not look at extraneous notifications.

FIG. 6B shows a user interface 620 utilized in publishing a new group event. The group event may include an image 621 describing an item 623 (e.g., an apple). Further, the user may select one or more categories 625 (e.g., local, produce, fruits, etc.), a discount 627 amount, a location 629 (e.g., a shop name), the number 631 of items required to trigger the discount, a discount price 633, and a time requirement 635. FIG. 6C displays a user interface 640 of a history 641 of purchases and/or group events that the user has partaken in. The user may navigate through the history 641 to view group information 643 associated with the history 641. Moreover, the user may view one or more lists of subscription options in the user interface 660 of FIG. 6D. The user interface 660 shows various categories of items, locations, etc. that can be utilized as parameters and criteria for choosing relevant notifications to receive by the user.

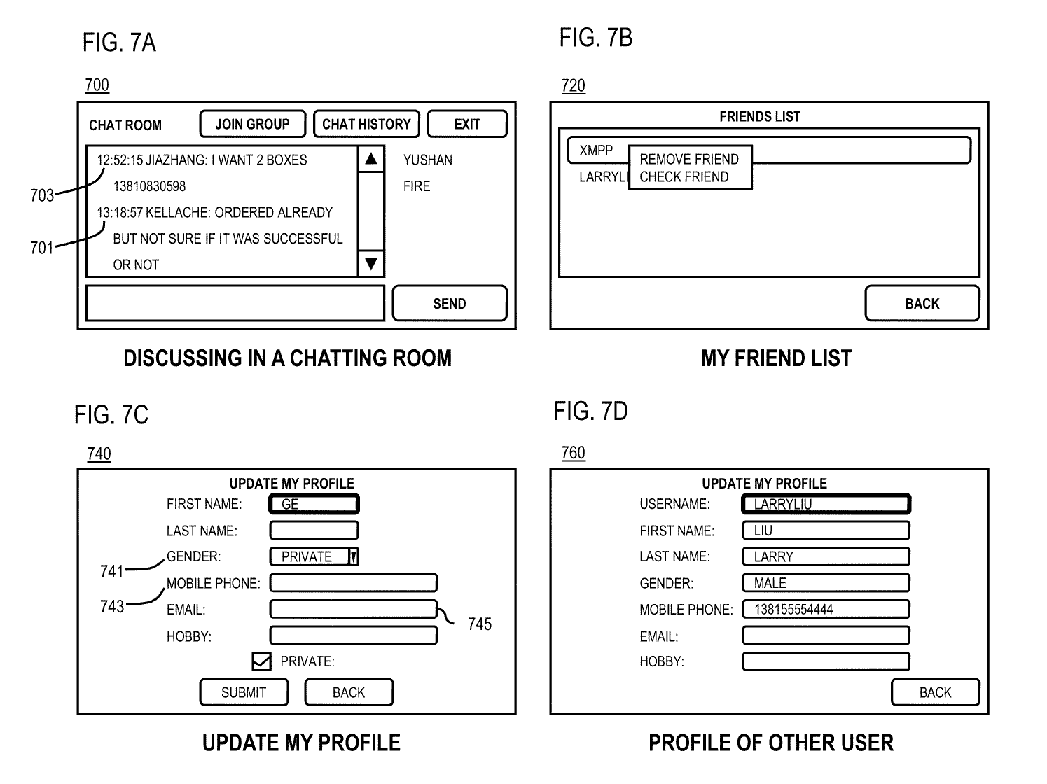

FIG. 7A shows a user interface 700 of a communication after a notification for a group event has been sent. The user interface 700 shows a chat between the initiating user 701 and another user 703 inquiring about a group event that the initiating user 701 set up. When the notification is set out, a group chat including the users can be set up so that members of the group notified may ask questions and receive responses. FIG. 7B includes a user interface 720 that allows the user to choose to add and/or remove a contact from a group to a friends or contacts list. In this manner, the user may quickly and easily identify group events associated with friends/contacts that the user has previously done business with. In certain scenarios, the user can subscribe to group events generated by and/or including one or more of the contacts.

FIGS. 7C and 7D present user interfaces 740, 760 associated with user profiles of two different users. A first user updates the user's information in user interface 740. The update may include an option to keep the user's information private. In this manner, the user may keep certain information (e.g., gender 741, contact information such as phone number 743, e-mail 745, etc.) private from other users. As such, the information may be collected by the group purchasing platform 103, but not shared with other users. Further, certain details may be left blank and not collected by the group purchasing platform 103. As shown in FIG. 7D, some users may determine to share the users' information with additional users.

With the above approaches, a user is able to receive notifications about group events. These notifications can be part of organizing the group events. Group events can further be utilized in activities, such as purchasing items. Further, a group event platform can be utilized to efficiently match published events (e.g., deals) with users' subscriptions for group events. The notifications can further be based on momentary locations of UEs 101. As such, a distance parameter associated with a UE 101 of the user can be utilized in providing the user relevant group event opportunities. With this approach, the user is provided a customized view of relevant group events by effectively preventing spam notices.

The processes described herein for organizing group events may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

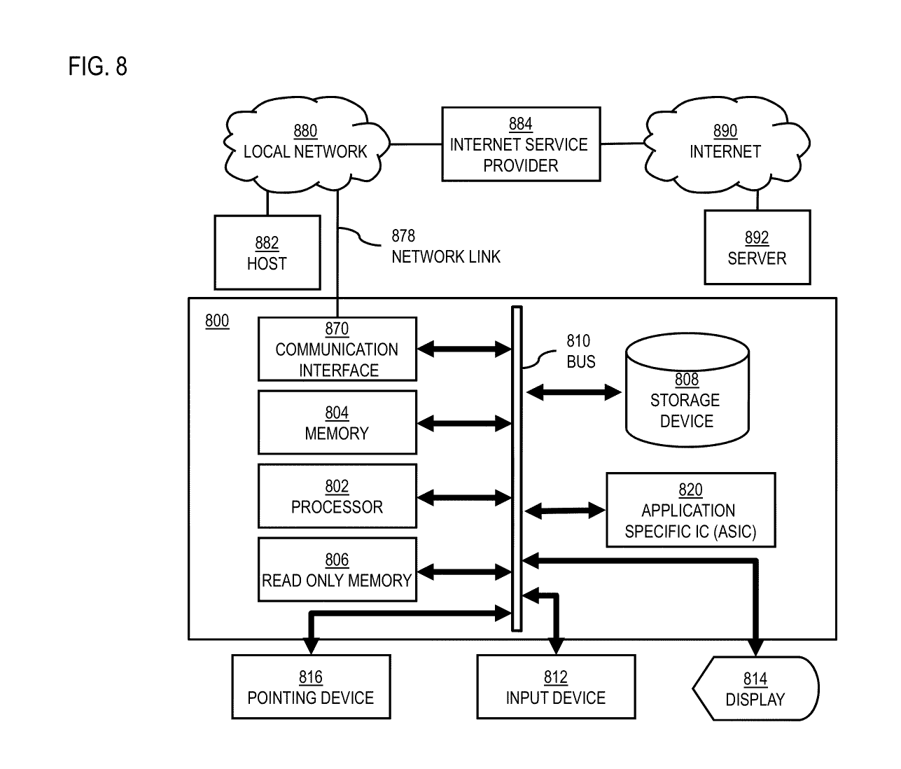

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to organize group events as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of organizing group events.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to organize group events. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for organizing group events. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for organizing group events, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to organize group events as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of organizing group events.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to organize group events. The memory 905 also stores the data associated with or generated by the execution of the inventive steps.

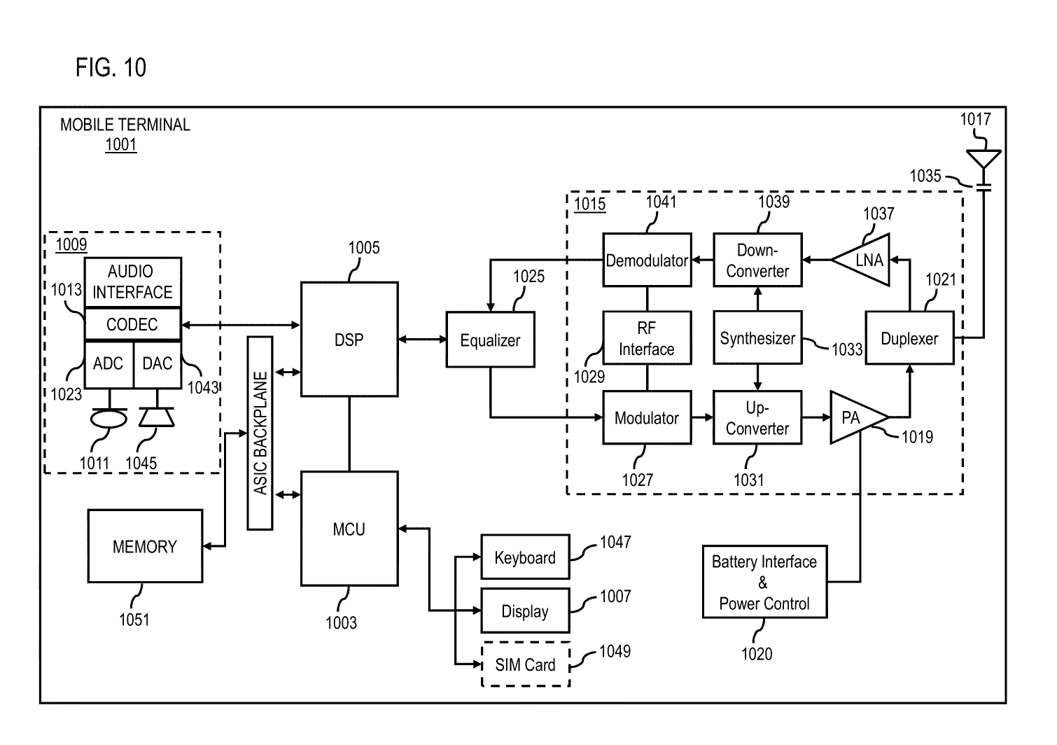

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of organizing group events. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of organizing group events. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to organize group events. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1.-27. (canceled)

28. A method comprising facilitating a processing of and/or processing (1) data and/or (2) information and/or (3) at least one signal, the (1) data and/or (2) information and/or (3) at least one signal based, at least in part, on the following:
an input from a device specifying a group event;
at least one determination of a location associated with the group event;
at least one determination of one or more other devices within proximity of the location; and
a generation of a notification of the group event to the one or more other devices.

29. A method of claim 28, wherein the (1) data and/or (2) information and/or (3) at least one signal are further based, at least in part, on the following:
at least one determination of one or more categories associated with the group event;
at least one determination of respective subscription information corresponding to the one or more other devices, the subscription information associated with the one or more categories; and
at least one determination to transmit the notification to the one or more devices based, at least in part, on the subscription information.

30. A method of claim 29, wherein the subscription information includes a respective distance parameter for the one or more other devices, and wherein the transmission of the notification is further based, at least in part, on the respective distance parameters.

31. A method of claim 28, wherein the (1) data and/or (2) information and/or (3) at least one signal are further based, at least in part, on the following:
at least one determination to transmit the notification to the one or more other devices based, at least in part, on one or more criteria, context information, or a combination thereof.

32. A method of claim 31, wherein the (1) data and/or (2) information and/or (3) at least one signal are further based, at least in part, on the following:
one or more responses to the notification from the one or more other devices; and
a formation of a group to engage in the group event based, at least in part, on the one or more responses.

33. A method of claim 32, wherein the (1) data and/or (2) information and/or (3) at least one signal are further based, at least in part, on the following:
one or more other inputs for specifying a respective rating of the one or more other devices in the group; and
at least one determination of the respective ratings for one or more other devices based, at least in part, on the one or more other inputs.

34. A method of claim 33, wherein the one or more other inputs are received from the device, the one or more other devices, a vendor associated with the group event, or a combination thereof.

35. A method of claim 34, wherein the group event is a purchase event, social event, travel event, or a combination thereof.

36. An apparatus comprising:
at least one processor; and
at least one memory including computer program code for one or more programs,
the at least one memory and the computer program code configured to, with the at least one processor, cause the apparatus to perform at least the following,
receive an input from a device specifying a group event;
determine a location associated with the group event;
determine one or more other devices within proximity of the location; and
generate a notification of the group event to the one or more other devices.

37. An apparatus of claim 36, wherein the apparatus is further caused to:
determine one or more categories associated with the group event;
determine respective subscription information corresponding to the one or more other devices, the subscription information associated with the one or more categories; and
determine to transmit the notification to the one or more devices based, at least in part, on the subscription information.

38. An apparatus of claim 37, wherein the subscription information includes a respective distance parameter for the one or more other devices, and wherein the transmission of the notification is further based, at least in part, on the respective distance parameters.

39. An apparatus of claim 36, wherein the apparatus is further caused to:
determine to transmit the notification to the one or more other devices based, at least in part, on one or more criteria, context information, or a combination thereof.

40. An apparatus of claim 39, wherein the apparatus is further caused to:
receive one or more responses to the notification from the one or more other devices; and
form a group to engage in the group event based, at least in part, on the one or more responses.

41. An apparatus of claim 40, wherein the apparatus is further caused to:
receive one or more other inputs for specifying a respective rating of the one or more other devices in the group; and
determine the respective ratings for one or more other devices based, at least in part, on the one or more other inputs.

42. An apparatus of claim 41, wherein the one or more other inputs are received from the device, the one or more other devices, a vendor associated with the group event, or a combination thereof.

43. An apparatus of claim 36, wherein the group event is a purchase event, social event, travel event, or a combination thereof.

44. A computer-readable storage medium carrying one or more sequences of one or more instructions which, when executed by one or more processors, cause an apparatus to at least perform the following steps:
receiving an input from a device specifying a group event;
determining a location associated with the group event;
determining one or more other devices within proximity of the location; and
generating a notification of the group event to the one or more other devices.

45. A computer-readable storage medium of claim 44, wherein the apparatus is caused to further perform:
determining one or more categories associated with the group event;
determining respective subscription information corresponding to the one or more other devices, the subscription information associated with the one or more categories; and
determining to transmit the notification to the one or more devices based, at least in part, on the subscription information.

46. A computer-readable storage medium of claim 45, wherein the subscription information includes a respective distance parameter for the one or more other devices, and wherein the transmission of the notification is further based, at least in part, on the respective distance parameters.

47. A computer-readable storage medium of claim 44, wherein the apparatus is caused to further perform:
determining to transmit the notification to the one or more other devices based, at least in part, on one or more criteria, context information, or a combination thereof.
